(19) United States
(12) Patent Application Publication
(10) Pub. No.: US 2020/0047598 A1
(43) Pub. Date: Feb. 13, 2020

(54) AUTO GUARD SYSTEM

(71) Applicant: Jonathan Garcia, Plainview, TX (US)

(72) Inventor: Jonathan Garcia, Plainview, TX (US)

(21) Appl. No.: 16/531,002

(22) Filed: Aug. 2, 2019

Related U.S. Application Data
(60) Provisional application No. 62/715,734, filed on Aug. 7, 2018.

(51) Int. Cl. B60J 11/04

(52) U.S. Cl. CPC B60J 11/04; B60Y 2200/14; B60Y 2200/11

(57) ABSTRACT

An auto guard system including an impact resistant cover panel configured to provide a protective, impact and weather resistant barrier for applying to a vehicle such as a car or pick-up truck. The impact resistant cover panel includes a body having a top surface, a bottom surface, and a padded-interior, and at least one anchor having an adjustable strap and a fastener for appropriately securing the impact resistant cover panel to various points of the vehicle.

### CROSS REFERENCE TO RELATED APPLICATION

The present application is related to and claims priority to U.S. Provisional Patent Application No. 62/715,734 filed Aug. 7, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of vehicle accessories and more specifically relates to a vehicle cover.

### 2. Description of Related Art

Inclement weather can cause serious damage to a vehicle's paint and windows. Hail and ice pummel the unprotected vehicle and may leave extensive scrapes and dents. If the weather is powerful enough, windshields and windows could begin to crack. Damage to a vehicle requires extensive and expensive repairs. A suitable solution is desired.

U.S. Pub. No. 2018/0111466 to Ming Wai Ching relates to a hail-resistant vehicle cover. The described hail-resistant vehicle cover includes a hail-resistant cover for a vehicle which may include a plurality of cover panels, each cover panel including a cover panel sleeve and an impact resistant cover panel insert. The cover panels may be affixed to each other by flexible cover panel joints which allow the cover panels to fold over onto the adjacent cover panels. The cover may also include anchors for anchoring the cover to the top of the vehicle. In some embodiments, the cover panels are removably affixed to the adjacent cover panels.

### BRIEF SUMMARY OF THE INVENTION

In view of the foregoing disadvantages inherent in the known vehicle accessory art, the present disclosure provides a novel auto guard system. The general purpose of the present disclosure, which will be described subsequently in greater detail, is to provide an auto-guard system.

An auto guard system is disclosed herein. The auto guard system includes various embodiments of an impact resistant cover panel configured to provide a protective, impact resistant barrier for applying to a vehicle such as a car or pick-up truck. The impact resistant cover panel includes a body comprising a top surface, a bottom surface, and a padded-interior, and at least one anchor comprising an adjustable strap and a fastener. The top surface, the bottom surface, and the padded-interior together form a thickness. The padded-interior comprises a rubber foam material or other similar, suitable material providing a cushion. The impact resistant cover panel preferably comprises a waterproof nylon material outer covering. The fastener may include cam lock style plastic buckles, j-hooks, hooks, strap-hooks, buckles, clips, and/or the like for appropriately securing the impact resistant cover panel to various points of the vehicle.

The impact resistant cover panel is configured to be manually placed on and extend over a substantial portion of an upper surface of a vehicle to provide protection. The bottom surface is in contact with the upper surface of the vehicle during an installed condition. A first end of the body is positioned at a front end of the vehicle during an in-use condition and a second end of the body is positioned at a rear end of the vehicle during an in-use condition. In a preferred embodiment, the impact resistant cover panel is configured to fold accordion style for convenient storage.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an auto guard system, constructed and operative according to the teachings of the present disclosure.

FIG. 1 is a perspective view of the auto guard system during an ‘in-use’ condition, according to an embodiment of the disclosure.

FIG. 2 is a perspective view of the auto guard system of FIG. 1, according to an embodiment of the present disclosure.

FIG. 3 is a top view of the auto guard system of FIG. 1, according to an embodiment of the present disclosure.

FIG. 4 is a perspective view of the auto guard system of FIG. 1, according to an embodiment of the present disclosure.

FIG. 5 is a perspective view of the auto guard system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a vehicle accessory and more particularly to an auto guard system as used to improve the protection of vehicles from sun, snow, hail and the like.

Generally, the present invention provides vehicles with a tight, protective, and foldable cover capable of preventing excessive dents, scrapes, and damages due to inclement weather. The device functions as a cover to maximize shade within the interior during sunny weather and to prevent snow from accumulating on the tops of a vehicle. It utilizes a series of nylon straps and magnets to firmly attach the cover to a vehicle. The cover may include straps for securing side portions of the device to door handles of a vehicle. The device extends from the front hood, over the windshield, on top of the roof, and then over the back window and trunk for optimal protection. The present invention folds up for convenient storage and transportation when not in use.

The cover is preferably comprised of a rubber foam interior with a waterproof nylon outer covering. The cover can be applied to a vehicle via a series of nylon straps and integrated magnetic strips. The system is secured over a hood, roof, and trunk for maximum protection. Users can extend and apply the cover to a vehicle. As the cover is fully extended, the nylon straps can be secured for a strong attachment. The magnetic strips help ensure the cover remains immobile even during inclement weather. The cover offers maximum protection from hail, ice, snow, rain, and other environmental elements, effectively preventing the need for costly vehicle repairs. The auto guard system may be available in numerous sizes, styles, and colors.

In another embodiment, the cover is provided for a pick-up truck. In this embodiment, the cover is specifically adapted for covering a pick-up truck and securing the cover to the pick-up truck. The cover may include two straps for securing the device to tow hooks located on a front end of a pick-up truck. The cover further comprises fender-flaps for covering a portion of a vehicle's fenders. The fender-flaps may be secured through either a tire or front leaf springs.

A top half of the cover may secure inside a cab of the vehicle via door wells. Once secured inside the door will be closed. Once the doors are closed there will be a flap on both sides of vehicle that folds down in order to protect the tops of the doors. The side flaps will then secure over the tops of the doors and on to vehicle via door handles. The back flap will cover approximately one foot of the rear window and will secure into the bed of the truck via cargo hooks. All straps utilized will be secured using Cam Lock style plastic buckles and/or SNAP-LOC strap hooks, or the like.

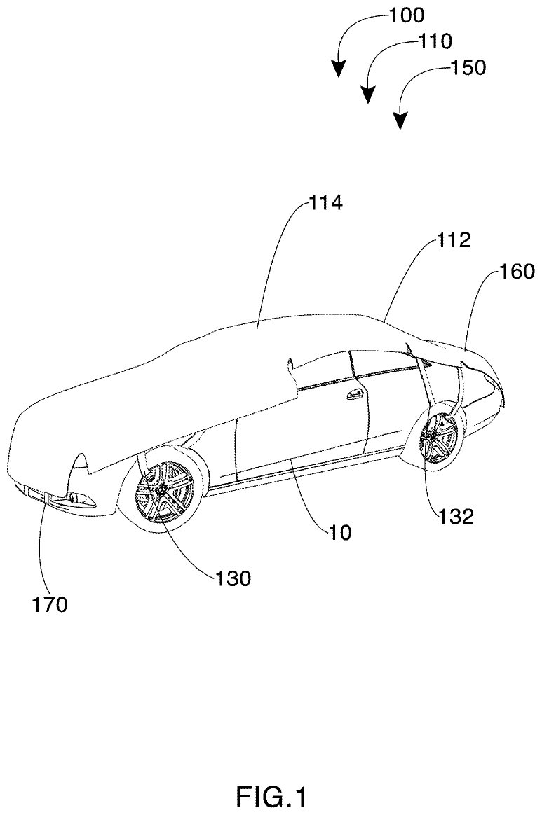

Referring now more specifically to the drawings by numerals of reference, there is shown in FIGS. 1-5, various views of an auto guard system 100. FIG. 1 shows an auto guard system 100 during an ‘in-use’ condition 150, according to an embodiment of the present disclosure. As illustrated, the guard system 100 may include a first embodiment adapted to be secured to a vehicle 10, specifically a car, comprising an impact resistant cover panel 110 having a body 112 comprising a top surface 114, a bottom surface 116, and a padded-interior 118, and at least one anchor 130. The top surface 114, the bottom surface 116, and the padded-interior 118 together form a thickness. The padded-interior 118 comprises a rubber foam material or other similar, suitable material providing a cushion. The impact resistant cover panel 110 preferably comprises a waterproof nylon material outer covering. The impact resistant cover panel 110 is configured to be manually placed on and extend over a substantial portion of an upper surface of a vehicle 10 to provide protection. The bottom surface 116 is in contact with the upper surface of the vehicle 10 during an installed condition. A first end 120 of the body 112 is positioned at a front end of the vehicle 10 during an in-use condition and a second end 122 of the body 112 is positioned at a rear end of the vehicle 10 during an in-use condition. In a preferred embodiment, the impact resistant cover panel 110 is configured to fold accordion style for convenient storage.

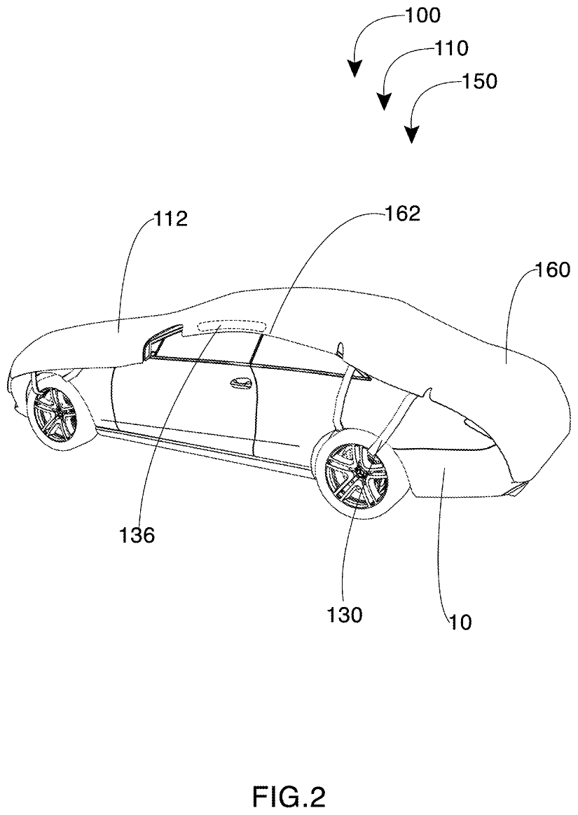

FIG. 2 shows a perspective view of the auto guard system 100 of FIG. 1, according to an embodiment of the present disclosure. As above, the auto guard system 100 may include the impact resistant cover panel 110 having at least one anchor 130 comprising an adjustable strap 132 and a fastener 134. A first end of the adjustable strap 132 is attached to the impact resistant cover panel 110 and the fastener 134 is positioned at a second end of the adjustable strap 132. In a preferred embodiment, the adjustable strap 132 is length adjustable to accommodate various sized vehicles 10 and firmly secure the impact resistant cover panel 110. The adjustable strap 132 may comprise a nylon material or other suitable material. The fastener 134 may include cam lock style plastic buckles, j-hooks, hooks, strap-hooks, buckles, clips, and the like for appropriately securing the impact resistant cover panel 110 to various points of the vehicle 10. The auto guard system 100 may further include at least one magnetic strip fastener 136 to further secure the impact resistant cover panel 110 to the upper surface of the vehicle 10 to provide protection. The magnetic strip fastener 136 attaches to the cover panel 110 and holds the cover panel touching the (steel) car body.

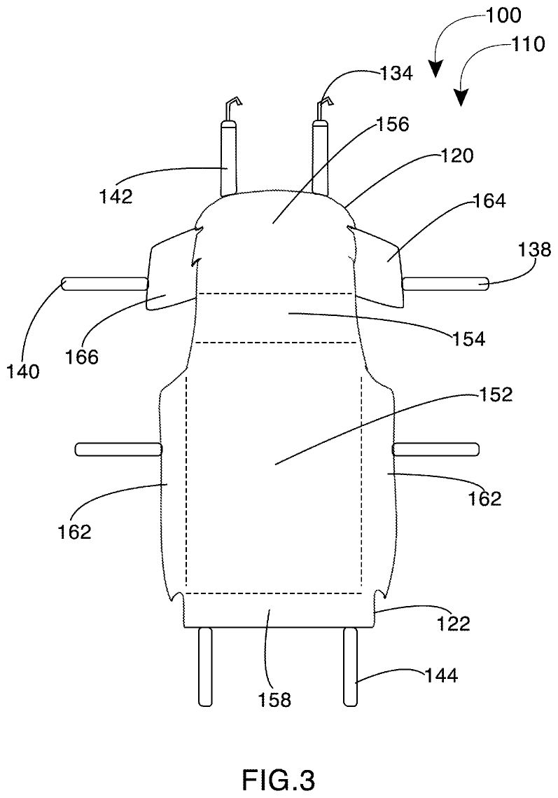

FIG. 3 shows a top view of the auto guard system 100 of FIG. 1, according to an embodiment of the present disclosure. As above, the auto guard system 100 may include the impact resistant cover panel 110 having at least one anchor 130 which may include right-side anchors, left-side anchors, front anchors, and rear anchors. In some versions, the impact resistant cover panel 110 is divided into sections including a roof section 152, a front-windshield section 154, a hood section 156, a rear-windshield section 158, and a trunk section 160 each being secured using at least one of anchor 130. In other versions, a trunk section 160 is not included. The body 112 further extends over a right-side and a left-side of the vehicle 10 forming door cover flaps 162 configured to cover a top portion of a vehicle door on the right-side and the left-side of the vehicle 10. The door cover flaps 162 are anchored via at least one anchor 130 to door handles on respective sides of the vehicle 10.

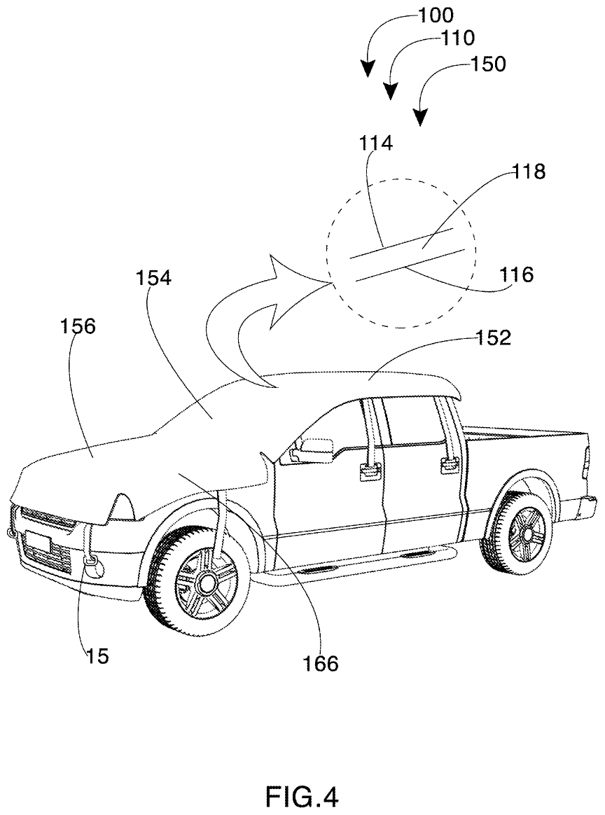

FIG. 4 shows a perspective view of the auto guard system 100 of FIG. 1, according to an embodiment of the present disclosure. As above, the auto guard system 100 may include a second version adapted to be secured to a vehicle 10, specifically a pick-up truck, the second version comprising an impact resistant cover panel 110 having a body 112 comprising a top surface 114, a bottom surface 116, and a padded-interior 118, and at least one anchor 130. The top surface 114, the bottom surface 116, and the padded-interior 118 together form a thickness.

The padded-interior 118 comprises a rubber foam material. The thickness provides a cushion to protect a vehicle 10 against impact energy damage such as hail. The impact resistant cover panel 110 comprises a waterproof nylon material outer covering. The at least one anchor 130 comprises an adjustable strap 132 and a fastener 134. A first end of the adjustable strap 132 is attached to the impact resistant cover panel 110 and the fastener 134 is positioned at a second end of the adjustable strap 132. The fastener 134 may include cam lock style plastic buckles, j-hooks, hooks, strap-hooks, buckles, clips, and the like. The impact resistant cover panel 110 is configured to be manually placed on and extend over a substantial portion of an upper surface of a pick-up truck. The bottom surface 116 is in contact with the upper surface of the pick-up truck when installed. The impact resistant cover panel 110 is secured to the upper surface of the pick-up truck via the at least one anchor 130 and provides protection. Some versions also comprise a magnetic strip fastener 136 to attach the auto guard system 100.

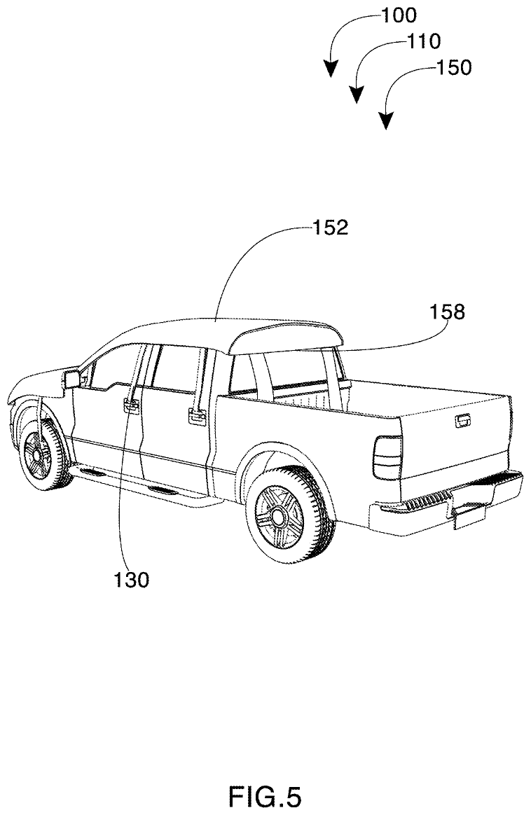

FIG. 5 shows a perspective view of the auto guard system 100 of FIG. 1, according to an embodiment of the present disclosure. As above, the auto guard system 100 may include the impact resistant cover panel 110 having a roof section 152, a front-windshield section 154, a hood section 156, a right-side fender section 164, a left-side fender section 166, and a rear-windshield section 158. In some versions, as previously described, the impact resistant cover panel 110 includes at least one anchor 130. More specifically, at least one of the at least one anchor 130 includes two front-straps 170 configured to secure the hood section 156 of the impact resistant cover panel 110 to tow hooks 15 of the pick-up truck. The rear-windshield section 158 extends approximately 1 foot down from a roof of a pick-up truck to partially cover a rear-windshield. The at least one anchor 130 can also be selected from mirror anchors, tire anchors, door handle anchors, and truck box anchors.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An auto guard system comprising:
an impact resistant cover panel having
a body comprising
a top surface;
a bottom surface;
and
a padded-interior disposed between the top surface and the bottom surface together forming a thickness;
and
at least one anchor,
wherein the impact resistant cover panel is configured to be manually placed on and extend over a substantial portion of an upper surface of a vehicle to provide protection, the bottom surface being in contact with the upper surface of the vehicle.

2. The auto guard system of claim 1, wherein the at least one anchor comprises an adjustable strap and a fastener, a first end of the adjustable strap is attached to the impact resistant cover panel and the fastener is positioned at a second end of the adjustable strap.

3. The auto guard system of claim 2, wherein the adjustable strap is length adjustable.

4. The auto guard system of claim 3, wherein the adjustable strap comprises a nylon material.

5. The auto guard system of claim 2, wherein the fastener is selected from the group consisting of: cam lock style plastic buckles, j-hooks, hooks, strap-hooks, buckles, and clips.

6. The auto guard system of claim 1, further comprising at least one magnetic strip fastener to further secure the impact resistant cover panel to the upper surface of the vehicle.

7. The auto guard system of claim 2, wherein the at least one anchor comprises right-side anchors, left-side anchors, front anchors, and rear anchors.

8. The auto guard system of claim 1, wherein the body extends over a right-side and a left-side of the vehicle forming door cover flaps configured to cover a top portion of a vehicle door on the right-side and the left-side of the vehicle.

9. The auto guard system of claim 8, wherein the door cover flaps are anchored via at least one anchor.

10. The auto guard system of claim 1, wherein the impact resistant cover panel includes a roof section, a front-windshield section, a hood section, a rear-windshield section, and a trunk section.

11. The auto guard system of claim 1, wherein the impact resistant cover panel is configured to fold.

12. The auto guard system of claim 1, wherein the padded-interior comprises a rubber foam material.

13. The auto guard system of claim 1, wherein the impact resistant cover panel comprises a waterproof nylon material outer covering.

14. The auto guard system of claim 1, wherein a first end of the body is positioned at a front end of the vehicle during an in-use condition and a second end of the body is positioned at a rear end of the vehicle during an in-use condition.

15. An auto guard system, the auto guard system comprising:
an impact resistant cover panel having;
a body comprising;
a top surface;
a bottom surface;
and
a padded-interior a padded-interior disposed between the top surface and the bottom surface together forming a thickness;
at least one anchor;
wherein the padded-interior comprises a rubber foam material providing a cushion;
wherein the impact resistant cover panel comprises a waterproof nylon material outer covering;
wherein the at least one anchor comprises an adjustable strap and a fastener, a first end of the adjustable strap is attached to the impact resistant cover panel and the fastener is positioned at a second end of the adjustable strap;
wherein the impact resistant cover panel is configured to be manually placed on and extend over a substantial portion of an upper surface of a pick-up truck, the bottom surface being in contact with the upper surface of the pick-up truck;
and
wherein the impact resistant cover panel is secured to the upper surface of the pick-up truck via the at least one anchor.

16. The auto guard system of claim 15, wherein the impact resistant cover panel includes a roof section, a front-windshield section, a hood section, a right-side fender section, a left-side fender section, and a rear-windshield section.

17. The auto guard system of claim 16, wherein the at least one anchor comprises two front-straps configured to secure the hood section of the impact resistant cover panel to tow hooks of the pick-up truck.

18. The auto guard system of claim 17, wherein the at least one anchor further includes mirror anchors, tire anchors, door handle anchors, and truckbox anchors.

19. The auto guard system of claim 1, wherein the fastener is selected from the group consisting of: cam lock style plastic buckles, j-hooks, hooks, strap-hooks, buckles, and clips.

20. An auto guard system, the auto guard system comprising:
an impact resistant cover panel having;
a body comprising;
a top surface;
a bottom surface;
and
a padded-interior disposed between the top surface and the bottom surface together forming a thickness;
at least one magnetic strip fastener;
and
at least one anchor,
wherein the impact resistant cover panel is configured to be manually placed on and extend over a substantial portion of an upper surface of a vehicle, the bottom surface being in contact with the upper surface of the vehicle;
wherein the at least one anchor comprises right-side anchors, left-side anchors, front anchors, and rear anchors;
wherein the at least one anchor comprises an adjustable strap and a fastener, a first end of the adjustable strap is attached to the impact resistant cover panel and the fastener is positioned at a second end of the adjustable strap;
wherein the adjustable strap is length adjustable;
wherein the adjustable strap comprises a nylon material;
wherein the fastener is selected from the group consisting of cam lock style plastic buckles, j-hooks, hooks, strap-hooks, buckles, and clips;
wherein the body further extends over a right-side and a left-side of the vehicle forming door cover flaps configured to cover a top portion of a vehicle door on the right-side and the left-side of the vehicle;
wherein the door cover flaps are anchored via at least one anchor to door handles on respective sides of the vehicle;
wherein the impact resistant cover panel is configured to fold accordion style;
wherein the padded-interior comprises a rubber foam material providing a cushion;
and
wherein the impact resistant cover panel comprises a waterproof nylon material outer covering.
